(19) United States
(12) Patent Application Publication
(10) Pub. No.: US 2026/0081921 A1
(43) Pub. Date: Mar. 19, 2026

(54) System and Method for Real-Time Sensitivity Assessment and Management in Digital Communication Platforms

(71) Applicant: Taito Learning, Inc., Helsinki (FI)

(72) Inventor: Hannu Daniel Sehm, Espoo (FI)

(21) Appl. No.: 18/885,830

(22) Filed: Sep. 16, 2024

(51) Int. Cl. H04L 9/40; G06F 40/279; G06F 40/30

(52) U.S. Cl. CPC H04L 63/102; G06F 40/279; G06F 40/30; H04L 63/107; H04L 63/108

(57) ABSTRACT

A method for real-time sensitivity assessment in a digital communication platform that includes receiving data inputs from one or more sources in one or more formats, pre-processing the received data inputs to normalize the data inputs, analyzing the pre-processed data inputs with a natural language processing (NLP) algorithm to determine sensitive information included in the data inputs, running a machine learning model on the sensitive information to determine a sensitivity level of the sensitive information based on context and sentiment of the sensitive information, generating sensitivity tags based on the determined sensitivity level, assigning the generated sensitivity tags to corresponding data inputs of the received data inputs, dynamically adjusting access permissions for users based on the assigned sensitivity tags, roles of the users, and contextual factors, and granting or denying access to the sensitive information based on the dynamically adjusted access permissions.

### TECHNICAL FIELD

The present invention relates to systems and methods for real-time sensitivity assessment and management in digital communication platforms. Specifically, it involves the detection, tagging, and controlled access of sensitive information across various types of communication platforms, including but not limited to educational institutions, corporate environments, healthcare systems, and social media networks. The invention aims to enhance data privacy, security, and compliance with data protection regulations through advanced techniques such as natural language processing, machine learning, and predictive analytics.

### BACKGROUND

Digital communication platforms have become essential tools for interactions across various sectors, including education, corporate environments, healthcare, and social media. However, ensuring the privacy and security of user data remains a significant challenge. Current systems often lack the ability to dynamically assess the sensitivity of communication in real-time, which can lead to potential privacy breaches and inadequate protection of sensitive information.

These platforms frequently process various forms of data inputs, including text, voice, and video. Each of these data types can contain sensitive information that must be appropriately managed to protect user privacy. However, existing systems typically rely on static sensitivity tags and do not account for changes in context or user behavior, resulting in misclassification and improper handling of sensitive data.

Moreover, the context and sentiment of communication play a crucial role in determining the sensitivity of information. Without advanced contextual analysis, systems may fail to accurately assess the sensitivity level, potentially exposing sensitive information to unauthorized access.

Additionally, predictive analytics have emerged as a valuable tool for anticipating future access needs and behaviors.

In various settings, such as educational institutions, corporate environments, and healthcare facilities, it is essential to provide intuitive interfaces for both administrators and end-users to manage and review sensitivity tags and access permissions. Administrators need tools to monitor interactions while respecting privacy, and end-users require mechanisms to control their own data privacy settings.

Finally, compliance with evolving data protection regulations, such as GDPR, HIPAA, FERPA and COPPA, is vital. Organizations and digital communication platforms must ensure that their systems meet regulatory requirements to avoid legal repercussions and maintain user trust.

By addressing these challenges, the present invention offers a comprehensive solution for real-time sensitivity assessment and management in digital communication platforms. It enhances the privacy and security of user interactions, provides dynamic access control, and ensures compliance with data protection regulations, making it an essential tool for modern communication needs across various sectors.

### SUMMARY

The present invention provides a system and method for real-time sensitivity assessment and management in digital communication platforms. The system includes a real-time sensitivity assessment module that analyzes user-provided content using natural language processing (NLP) and contextual analysis to detect sensitive information. A dynamic sensitivity tagging mechanism generates and attaches metadata to the detected sensitive content. An access control module dynamically adjusts access permissions based on the sensitivity metadata, user roles, and contextual factors.

The invention also features a user dashboard with privacy filters and a user privacy management interface, enhancing data privacy and security while ensuring compliance with data protection regulations. The system's modular design allows it to be adapted for use in various type of communication platforms, such as corporate communication systems, healthcare communication networks, and social media platforms, where real-time sensitivity assessment and controlled access to sensitive information are critical.

### BRIEF DESCRIPTION OF THE DRAWINGS:

FIG. 1: Overview of the system architecture for sensitivity-aware communication monitoring.

FIG. 2: Flowchart of the real-time sensitivity assessment process.

FIG. 3: Diagram illustrating the dynamic sensitivity tagging and metadata generation mechanism.

FIG. 4: User interface and core system components.

FIG. 5: Diagram of the privacy management system with real-time monitoring and compliance reporting.

FIG. 6: Predictive access control system for dynamically adjusting access permissions based on user behavior and historical data.

### DETAILED DESCRIPTION:

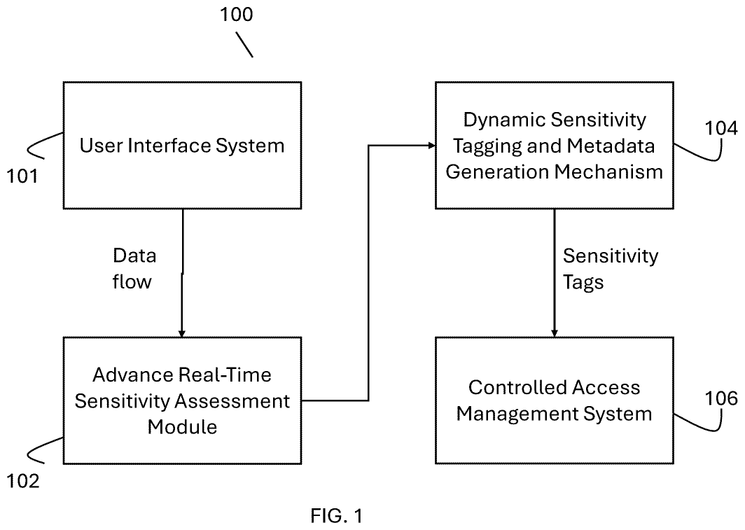

The FIG. 1 is a diagram depicting an overall system architecture 100 for real-time sensitivity assessment, dynamic sensitivity tagging, and controlled access management in a digital communication platform. The system includes four main components: A User Interface 101, an Advance Real-Time Sensitivity Assessment Module 102, a Dynamic Sensitivity Tagging and Metadata Generation Mechanism 104, and a Controlled Access Management System 106.

The User Interface 101 allow users to interact with the system, view their data access logs, manage consent preferences, and report inaccuracies in data tagging or unauthorized access incidents and provide a comprehensive dashboard for administrators to monitor the entire system's operations to ensure that sensitivity assessments and access controls are working correctly. The Advance Real-Time Sensitivity Assessment Module 102 receives data inputs through the User interface 101, from a variety of sources and in a variety of formats, such as text, voice, and video. The Advance Real-Time Sensitivity Assessment Module 102 pre-process the received data inputs to normalize the information. For example, the Advance Real-Time Sensitivity Assessment Module 102 may convert speech to text, compress video files, cleanse text data, among others. The pre-processed data inputs may be analyzed using a natural language processing (NLP) algorithm to identify sensitive information. The NLP algorithm may include sentiment analysis to determine an emotional tone of the received data inputs. Also, a machine learning model may be used to determine a sensitivity level of the identified sensitive information based on context and sentiment of the identified sensitive information. The machine learning model may be trained on a dataset including historical received data inputs and sensitivity assessment outcomes.

Once the sensitivity level is determined, the data may be provided to a Dynamic Sensitivity Tagging and Metadata Generation Mechanism 104. The Dynamic Sensitivity Tagging and Metadata Generation Mechanism 104 may generate sensitivity tags based on the determined sensitivity level. The sensitivity tags may be generated based on predefined sensitivity levels that are adjustable based on changes in data protection regulations and user's configurations. The sensitivity tags may be assigned to corresponding data inputs. The tagging mechanism store the tags in a secure metadata repository accessible only to authorized users. In some aspects, the sensitivity tags may include compliance tags for ensuring that the data inputs meet particular regulatory requirements (e.g., GDPR, HIPAA, FERPA, COPPA etc.). By last, the tagging mechanism may update the sensitivity tags dynamically based on user feedback and changes in organizational policies.

The sensitivity tags generated by the Dynamic Sensitivity Tagging and Metadata Generation Mechanism 104 are used by the Controlled Access Management System 106 to dynamically adjust access permissions for users based on the assigned sensitivity tags, user roles, and contextual factors such as user location, device security status, and time of access. The access permissions are further adjusted using predictive analytics that anticipate future access needs of the users. The system adjusts access permissions in real-time based on the security status of the user's device (e.g., whether the device is connected to a secure network). The sensitivity tags are used to generate audit trails that document all sensitivity assessments and access events for regulatory compliance. The sensitivity tags are applied to both data inputs and any associated metadata for comprehensive sensitivity management. Automated alerts may be triggered to administrators when sensitive information is accessed or modified.

In summary, the overall system architecture 100 includes the User Interface 101 the Advance Real-Time Sensitivity Assessment Module 102, the Dynamic Sensitivity Tagging and Metadata Generation Mechanism 104, and the Controlled Access Management System 106 to provide a comprehensive solution for managing sensitive information in real-time across digital communication platforms.

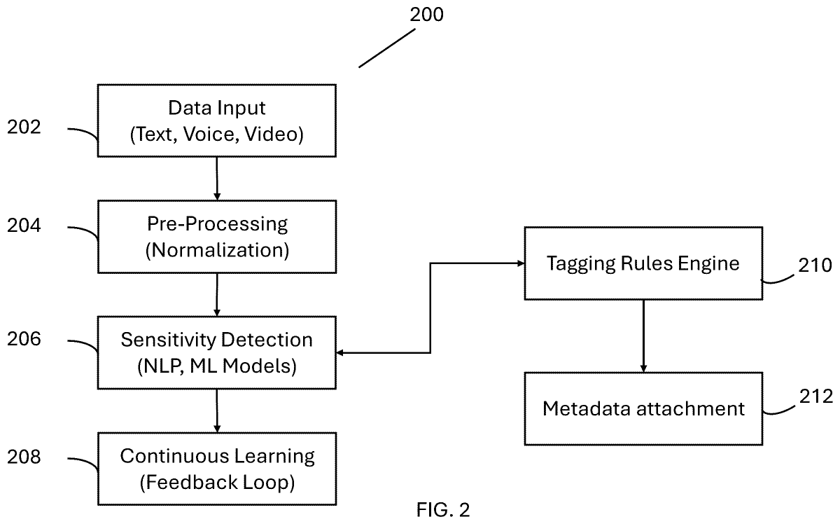

FIG. 2 is an example of how the Real-Time Sensitivity Assessment Module 200 operates, which is a component of the overall system architecture for managing the sensitive information. This module may be configured by receiving and processing data inputs 202 in real-time to detect and manage sensitive information.

After receiving the input data, the process Data Input 202 can proceed to the Pre-Processing step 204. In step 204, the received input data can be normalized to ensure consistency and compatibility for further analysis. The pre-processing can include converting speech to text during online lectures, compressing video files for efficient storage, and cleansing text data from student submissions to remove any extraneous or irrelevant information.

Once the data is pre-processed, the process can proceed to the next step, Sensitivity Detection 206. In this stage 206, the normalized data is analyzed using a combination of NLP algorithms and ML models. The NLP algorithms are used to understand the content and context of the data, and the ML models are used to identify and classify sensitive information based on predefined criteria. The sensitivity detection process 206 may be further enhanced by performing sentiment analysis to determine an emotional tone of the data inputs 202, providing a deeper understanding of the context and potential sensitivity of the information.

The next step is the Continuous Learning process 208. In this stage, the NLP algorithms and ML models are continuously updated based on user feedback and new data inputs. The continuous learning process 208 allows the system to remain adaptive and responsive to evolving patterns of sensitive information and changing regulatory requirements.

In parallel with the sensitivity detection process 206, the system may include a Tagging Rules Engine 210 for determining the appropriate sensitivity tags for the detected sensitive information based on current regulatory and institutional policies. The tagging rules engine may update its rules in real-time as policies change to ensure that the sensitivity tags remain compliant with current data protection regulations.

At metadata attachment 212, the generated sensitivity tags are attached to the corresponding data inputs. The metadata tags may include a sensitivity level of the content and access restrictions based on the determined sensitivity. The metadata tags may be embedded in the data or stored in a secure metadata repository accessible only to authorized users. The metadata attachment process preserves the sensitivity information for use in subsequent processing and access decisions.

In summary, the Real-Time Sensitivity Assessment component 200 of FIG. 2 includes data input 202, pre-processing 204, sensitivity detection 206, continuous learning 208, tagging rules engine 210 and metadata attachment 212 to provide a comprehensive and adaptive solution for managing sensitive information in digital communication platforms. The module can handle various data formats and includes advanced NLP and ML capabilities to perform accurate and efficient sensitivity assessment. The continuous learning and dynamic tagging mechanisms allow the module to stay current with changing data protection regulations.

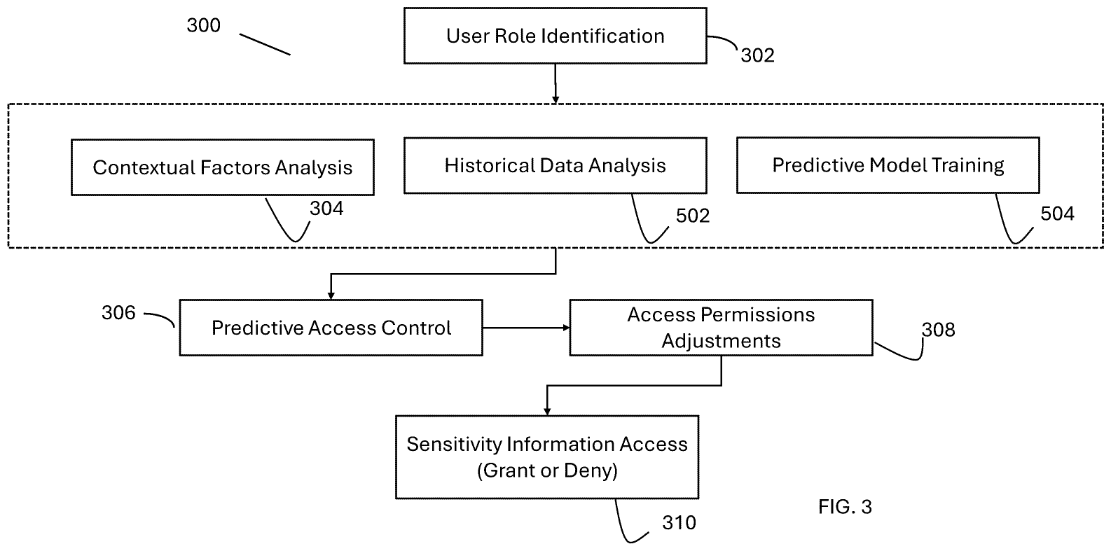

FIG. 3 is an example of a controlled access management system 300 for managing sensitive information in digital communication platforms. The controlled access management system 300 may be configured to dynamically adjust access permissions based on various factors to ensure that sensitive information is only accessible to authorized users under appropriate conditions.

Step 1 is User Role Identification 302. The system determines the role of the user who is attempting to access the sensitive information. The role of the user determines the baseline permissions associated with that role in the organization. For example, in educational institutions, a teacher may have more access rights than a student.

Once the user role has been determined, the process may proceed to the next step, Contextual Factors Analysis 304. In this module, the system may determine one or more contextual factors that may influence access permissions. Such factors may include, but are not limited to, the location of the user, the security status of the user's device, and a time of access. For example, an access request from a secure school network during school hours may be treated differently than an access request from a public Wi-Fi network outside of school hours.

At module Historical Data Analysis 502, the process involves collecting and analyzing historical data related to user interactions and access patterns. The analysis may include aggregating data from a variety of sources, such as previous access logs, user behavior records, and system usage statistics. The goal is to identify trends and patterns that can be used to inform future access control decisions. By understanding how users have interacted with the system in the past, the system can make more informed predictions about future access needs.

In the Predictive Model Training 504 module, the system can use the insights gained from the historical data analysis 502 to train predictive models. Predictive model Training 504 can use machine learning algorithms to learn from the historical data and identify factors that influence access needs and permissions. The training process can involve feeding large datasets into the models so that they can recognize patterns and correlations that may not be immediately apparent. Once trained, the models can make accurate predictions about future access requirements based on the analyzed data.

The information from the user role identification 302, contextual factors analysis 304, Historical Data Analysis 502 and Predictive Model Training 504 may be input into Predictive Access Control 306. In this step, predictive analytics may be used to predict future access needs based on historical behavior patterns and system usage trends. By analyzing past interactions and access requests, the system may predict and proactively adjust permissions to streamline access for authorized users while maintaining strict security controls.

At Access Permissions Adjustments 308, the access permissions may be dynamically adjusted based on the sensitivity tags assigned to the data inputs, the identified user role, and the analyzed contextual factors. The adjustments may tune the access permissions to a current context for an additional layer of security. For example, if it is determined that a device of the user is not connected to a secure network, then access to highly sensitive information may be restricted.

At Sensitive Information Access 310, access to the sensitive information is granted or denied to a user based on the dynamically adjusted permissions 308. Responsive to the access conditions meeting the required security and sensitivity criteria, access to the sensitive information is granted to the user. Otherwise, access is denied, and an alert may be generated to notify administrators of an attempted access.

The controlled access management system 300 of FIG. 3 includes user role identification 302, contextual factors analysis 304, predictive access control 306, and access permissions adjustments 308 for controlling access to sensitive information 310.

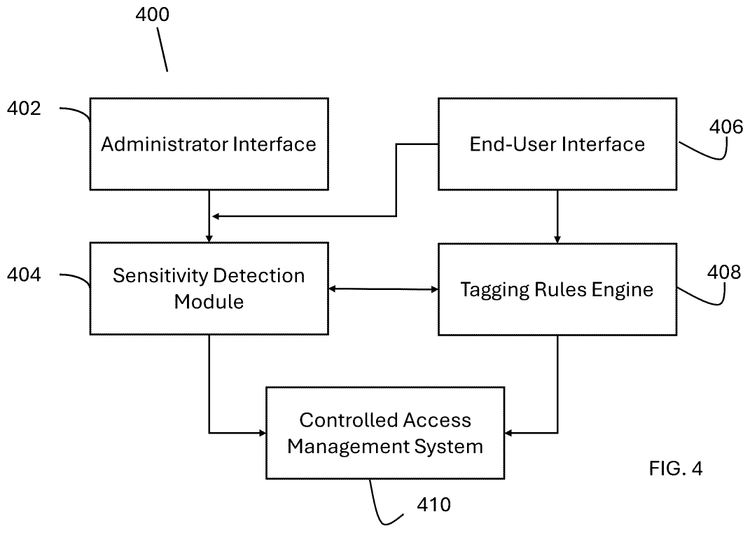

FIG. 4 is a diagram illustrating the user interface and system components 400 for digital communication platform for managing sensitive information in real-time. The system includes different modules that are communicatively coupled to one another and configured to manage sensitive information in real-time.

The Administrator Interface 402 is a central component that allows system administrators to configure sensitivity rules, review automated tagging decisions within the Tagging Rules Engine 408, and manage user roles and permissions that are reflected in the User Role Identification module 302 and Access permission adjustments 308. The Administrator Interface 402 provides a comprehensive dashboard for administrators to monitor the entire system's operations to ensure that sensitivity assessments and access controls are working correctly. The Administrator Interface 402 is designed to be user-friendly and includes various tools and visualizations to help administrators make informed decisions about data sensitivity and access permissions.

The Sensitivity Detection Module 404 is communicatively coupled to the Administrator Interface 402. The Sensitivity Detection Module 404 is configured to receive incoming data and determine that the incoming data includes sensitive information. The Sensitivity Detection Module 404 may use advanced natural language processing (NLP) algorithms and machine learning models to evaluate the content and context of the incoming data. The Sensitivity Detection Module 404 may receive input data from a variety of sources, such as text, voice, video, etc., and determine that the input data includes sensitive information based on predefined criteria and contextual analysis. The Sensitivity Detection Module 404 may learn from user feedback and new input data over time to improve its accuracy and efficiency.

The End-User Interface 406 is another interface of the system and is for end-users of the system, such as students or teachers. The End-User Interface 406 allows users to interact with the system, view their data access logs, manage consent preferences, and report inaccuracies in data tagging or unauthorized access incidents.

The Tagging Rules Engine 408 may be communicatively coupled to the Sensitivity Detection Module 404 and the End-User Interface 406. The Tagging Rules Engine 408 may determine, based on current regulatory and institutional policies, the sensitivity tags to be assigned to the sensitive information that has been detected. The Tagging Rules Engine 408 may update its rules in real-time as policies change, such that the sensitivity tags assigned to sensitive information remain compliant with current data protection regulations. The Tagging Rules Engine 408 may generate metadata tags for the sensitive information and assign the metadata tags to the sensitive information. The metadata tags may include a classification of content of the sensitive information based on a sensitivity level of the sensitive information and any access restrictions associated with the sensitive information.

The Access Management System 410 is the last component of the interconnected framework. The Access Management System 410 uses the sensitivity tags generated by the Tagging Rules Engine 408 to dynamically adjust access permissions for users. The Controlled Access Management System 410 considers a variety of factors, including user roles, contextual factors such as location and device security status, and time of access, to determine the appropriate access permissions. The Controlled Access Management System 410 ensures that sensitive information is only accessible to authorized individuals under suitable conditions, thereby maintaining strict security controls while providing seamless access for authorized users.

FIG. 4 shows the system for managing sensitive information in educational digital communication platforms. The Administrator Interface 402, End-User Interface 406, Sensitivity Detection Module 404, Tagging Rules Engine 408, and Access Management System 410 may be used together to provide a system for real-time sensitivity assessment, dynamic sensitivity tagging, and controlled access management.

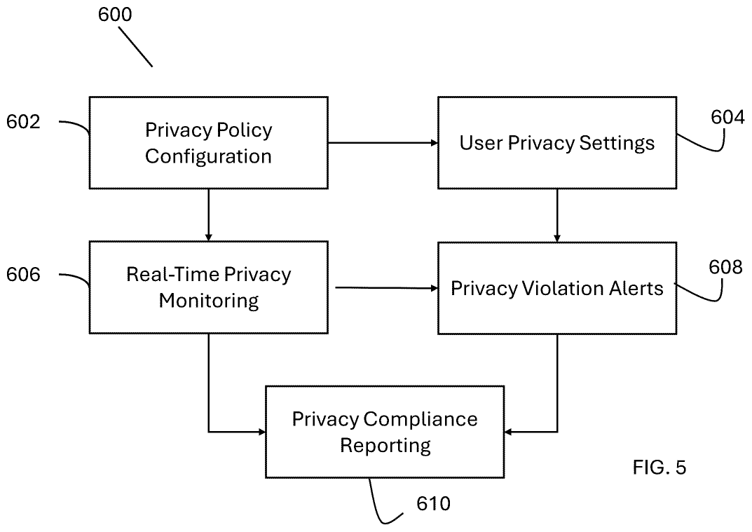

FIG. 5 shows the privacy management system 600 for managing privacy and security of sensitive information in a digital communication platform. The system may include multiple components that may be communicatively coupled with each other to monitor, manage, and report on privacy-related activities in real-time.

The first module is Policy Configuration 602, where administrators can set and update privacy policies according to organizational requirements and regulatory standards. The component allows for customization of privacy rules that govern how sensitive information is handled within the platform. Administrators can define what constitutes sensitive information and set guidelines for protecting it.

The system also includes the User Privacy Settings 604. The User Privacy Settings 604 allow end-users to manage their individual privacy preferences. The end-users may view and adjust settings related to the visibility and accessibility of their sensitive information. The interface allows end-users to control their data privacy, such that their personal information is handled according to their preferences.

Real-Time Privacy Monitoring 606 is a component that continuously monitors data interactions on the platform to ensure compliance with the configured privacy policies. The component may use advanced algorithms to analyze data in real-time to detect potential privacy violations or unauthorized access attempts. The continuous monitoring provided by Real-Time Privacy Monitoring 606 may help maintain the integrity and confidentiality of sensitive information.

If a privacy violation is detected, the system may trigger privacy violation alerts 608. The privacy violation alerts 608 may generate immediate alerts to notify administrators and other stakeholders of any breaches or unauthorized access incidents. The alerts may include information about the nature of the violation, allowing for prompt investigation and remediation.

The last component is the Privacy Compliance Reporting 610. The Privacy Compliance Reporting 610 generates reports of privacy-related activities, such as policy configurations, user settings, monitoring results, and violation alerts. The reports provide a detailed audit trail of all actions and events related to data privacy. The reports may be used to demonstrate compliance with regulatory requirements and for internal reviews and audits.

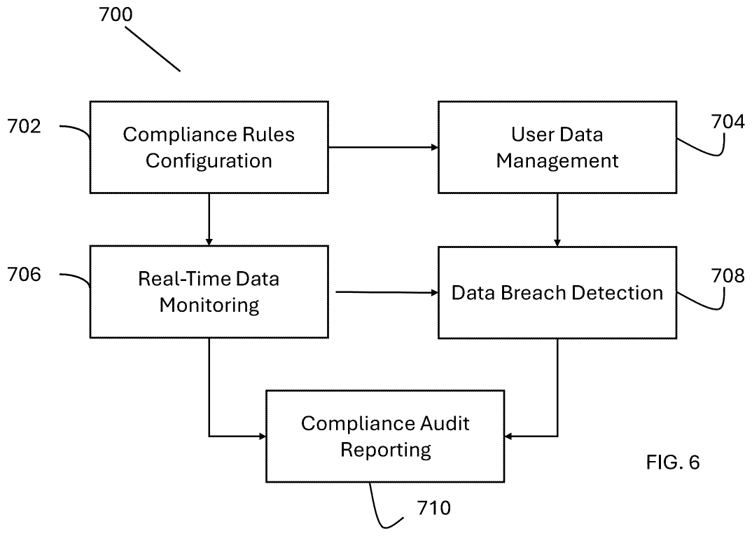

The privacy management system of FIG. 6 includes Privacy Policy Configuration 602, User Privacy Settings 604, Real-Time Privacy Monitoring 606, Privacy Violation Alerts 608, and Privacy Compliance Reporting 610.

The FIG. 6 illustrates the Compliance and Data Protection System 700 for ensuring that digital communication platforms comply with regulatory requirements and protect sensitive information. The system includes several components that are communicatively coupled together to ensure data integrity and compliance.

At Compliance Rules Configuration 702, where administrators can define and update rules and policies for data protection in the platform. The compliance rules may be customized to comply with various regulatory standards such as GDPR, HIPAA, FERPA, COPPA or other data protection laws. The configuration may include setting guidelines for identifying, handling, and protecting sensitive information to ensure that the operations of the platform are compliant with current regulations.

Once the compliance rules are configured, the system proceeds to User Data Management 704. The User Data Management 704 manages user data according to the configured compliance rules. The User Data Management 704 includes functionalities for storing, retrieving, and processing user data in accordance with the defined policies.

Real-Time Data Monitoring 706 is configured to continuously monitor data interactions on the platform for compliance with the configured rules. Real-Time Data Monitoring 706 can use advanced algorithms to analyze data in real-time to determine potential violations of the compliance rules. Real-Time Data Monitoring 706 can provide ongoing monitoring to identify any deviations from the policies that are established.

In response to a potential data breach, the system can trigger Data Breach Detection 708. The Data Breach Detection 708 can detect and respond to data breaches in real-time. The Data Breach Detection 708 can analyze the monitored data for signs of unauthorized access or other security incidents that may compromise sensitive information. Responsive to detecting a breach, the Data Breach Detection 708 can initiate one or more predefined response protocols for mitigating an impact of the breach and preventing additional unauthorized access.

The last component is Compliance Audit Reporting 710. Compliance Audit Reporting 710 generates reports related to compliance-related activities, such as rule configurations, data management practices, monitoring results, and breach detection incidents. Compliance Audit Reporting 710 provides a complete audit trail of the platform's compliance with regulatory requirements. The reports generated by Compliance Audit Reporting 710 may be used to demonstrate compliance during regulatory audits and for internal reviews to ensure continued compliance with data protection standards.

In one aspect, the Compliance and Data Protection System of FIG. 6 includes Compliance Rules Configuration 702, User Data Management 704, Real-Time Data Monitoring 706, Data Breach Detection 708, and Compliance Audit Reporting 710.

What is claimed is:

1. A method for real-time sensitivity assessment in a digital communication platform, the method comprising:
receiving data inputs from one or more sources in one or more formats selected from the group consisting of text, voice, and video;
pre-processing the received data inputs to normalize the data inputs, wherein the pre-processing comprises converting speech to text, compressing video files, and cleansing text data;
analyzing the pre-processed data inputs with a natural language processing (NLP) algorithm to determine sensitive information included in the data inputs;
running a machine learning model on the sensitive information to determine a sensitivity level of the sensitive information based on context and sentiment of the sensitive information;
generating sensitivity tags based on the determined sensitivity level;
assigning the generated sensitivity tags to corresponding data inputs of the received
data inputs;
dynamically adjusting access permissions for users based on the assigned sensitivity tags, roles of the users, and contextual factors including at least one of: a location of the user, a security status of a device of the user, and a time of access; and
granting or denying access to the sensitive information based on the dynamically adjusted access permissions.

2. The method of claim 1, wherein the natural language processing (NLP) algorithm further comprises sentiment analysis to determine the emotional tone of the data inputs.

3. The method of claim 1, wherein the machine learning model is trained on a dataset comprising historical data inputs and sensitivity assessment outcomes.

4. The method of claim 1, wherein the sensitivity tags are generated based on predefined sensitivity levels that are adjustable according to changes in data protection regulations.

5. The method of claim 1, wherein the contextual factors further include the type of communication channel used for the data inputs.

6. The method of claim 1, wherein the dynamically adjusted access permissions are further based on predictive analytics that anticipate future access needs of the users.

7. The method of claim 1, wherein the access permissions are adjusted in real-time based on the security status of the user's device, including whether the device is connected to a secure network.

8. The method of claim 1, wherein the sensitivity tags are stored in a secure metadata repository that is accessible only to authorized users.

9. The method of claim 1, wherein the sensitivity tags include compliance tags that ensure the data inputs meet specific regulatory requirements such as GDPR or HIPAA.

10. The method of claim 1, wherein the sensitivity tags are dynamically updated based on user feedback and changes in organizational policies.

11. The method of claim 1, wherein the access permissions are further adjusted based on the user's role within the organization, including specific departmental access levels.

12. The method of claim 1, wherein the sensitivity tags are used to generate audit trails that document all sensitivity assessments and access events for regulatory compliance.

13. The method of claim 1, wherein the sensitivity tags are applied to both the data inputs and any associated metadata to ensure comprehensive sensitivity management.

14. The method of claim 1, wherein the sensitivity tags are used to trigger automated alerts to administrators when sensitive information is accessed or modified.
